(19) United States
(12) Patent Application Publication
(10) Pub. No.: US 2007/0235502 A1
(43) Pub. Date: Oct. 11, 2007

(54) Condenser Microphone

(76) Inventor: Chien-Chin Hsiao, Hsin-Chu City (TW)

Correspondence Address: LADAS & PARRY LLP, 224 SOUTH MICHIGAN AVENUE, SUITE 1600, CHICAGO, IL, 60604, US

(21) Appl. No.: 11/393,122

(22) Filed: Mar. 30, 2006

(51) Int. Cl. A47J 36/02

(52) U.S. Cl. 228/101

(57) ABSTRACT

An electronic device suitable for a condenser microphone includes: first and second electrodes; and a housing defining an accommodating space for receiving the first and second electrodes therein and having a base that confines one side of the accommodating space and that has an outer surface which is provided with a first solder bump electrically connected to one of the first and second electrodes, and a plurality of second solder bumps connected electrically to the other of the first and second electrodes.

### BACKGROUND OF THE INVENTION

1. Field of the Invention

The invention relates to an electronic device, more particularly to a condenser microphone having a housing with a base that has a center and that is provided with a first solder bump at the center of the base, and a plurality of second solder bumps centered about the first solder bump.

2. Description of the Related Art

FIGS. 1 and 2 illustrate a conventional condenser microphone 9 that includes a base 91, a field effect transistor (FET) 92 mounted on the base 91, a metal ring 93 mounted on the base 91, a back plate 95 seated on the metal ring 93 and serving as a fixed electrode, a diaphragm 97 spaced apart from the back plate 95 by a spacer 96 and formed with a ring-shaped electrode 98 that serves as a movable electrode, and a casing 99 covering the assembly of the back plate 95, the diaphragm 97 and the FET 92 and formed with an opening 991 for passage of sound waves therethrough. The base 91 is formed with first and second holes 912 defined by hole-defining walls, and is further formed with first and second conductive layers 914, 915 on the hole-defining walls of the first and second holes 912, and a generally ring-shaped conductive layer 913. The FET 92 has a gate terminal lead 922 connected to the ring-shaped conductive layer 913, a source terminal lead 921 extending through the first hole 912 and connected to the first conductive layer 914, and a drain terminal lead (not shown) extending through the second hole 912 and connected to the second conductive layer 915.

The aforesaid conventional condenser microphone 9 is disadvantageous in that assembly of the same is relatively inconvenient and time-consuming.

Solder bumped electronic devices have been developed for many years. Through the solder bumps, these electronic devices can be conveniently attached to a printed circuit board using surface mount technology. However, the electronic devices are likely to incline slightly during surface mounting onto a printed circuit board or to another device due to poor geometrical distribution of the solder bumps thereon.

### SUMMARY OF THE INVENTION

Therefore, the object of the present invention is to provide an electronic device that is capable of overcoming the aforesaid drawbacks of the prior art.

According to this invention, there is provided an electronic device that comprises: first and second electrodes; and a housing defining an accommodating space for receiving the first and second electrodes therein and having a base that confines one side of the accommodating space and that has an outer surface which is provided with a first solder bump electrically connected to one of the first and second electrodes, and a plurality of second solder bumps connected electrically to the other of the first and second electrodes.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic sectional view of a conventional condenser microphone;

FIG. 2 is a schematic view to illustrate the configuration of conductive layers formed on a base of a housing of the conventional condenser microphone;

FIG. 3 is a schematic circuit diagram of the first preferred embodiment of a condenser microphone according to the present invention;

FIGS. 4 and 5 are schematic views to illustrate the configuration of solder bumps on a base of a housing of the first preferred embodiment;

FIG. 6 is a schematic view to illustrate the configuration of a conductive film on a circuit board which is adapted to be attached to the solder bumps of the first preferred embodiment;

FIG. 7 is a fragmentary schematic sectional view of the second preferred embodiment of the condenser microphone according to this invention;

FIG. 8 is a schematic circuit diagram of the third preferred embodiment of the condenser microphone according to this invention;

FIG. 9 is a schematic view to illustrate the configuration of first, second, and third solder bumps on a base of the third preferred embodiment; and

FIG. 10 is a schematic view to illustrate the configuration of a conductive film on a circuit board that is adapted to be connected to the first, second and third solder bumps of the third preferred embodiment.

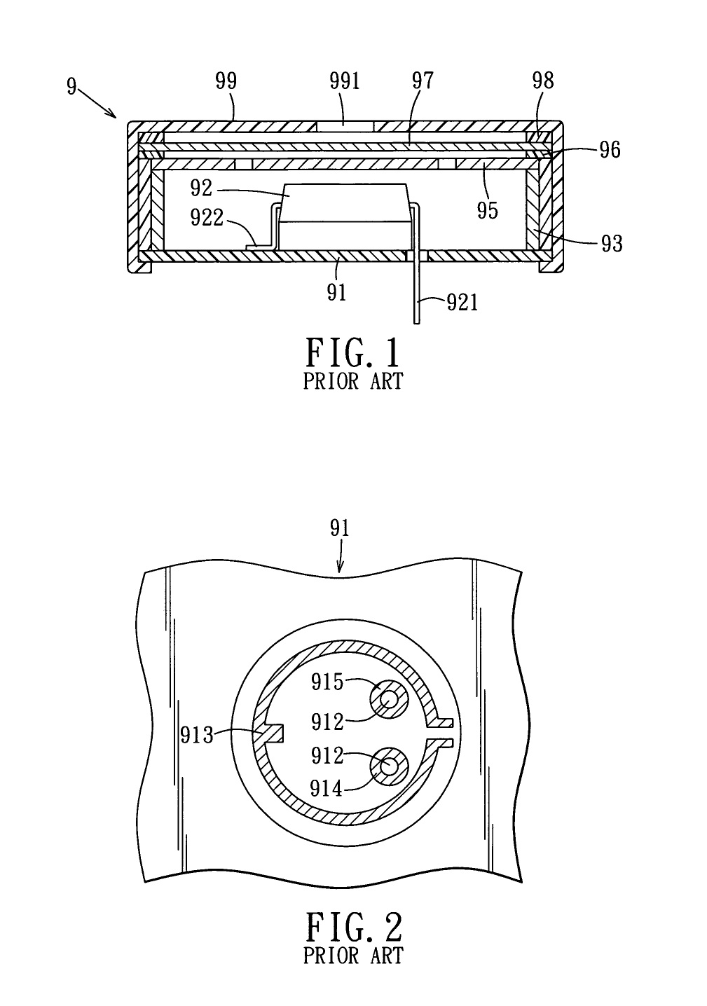

### DETAILED DESCRIPTION OF THE PREFERRED EMBODIMENTS

This invention relates to an electronic device that includes electronic components enclosed in a housing which has a base provided with solder bumps connected electrically to the electronic components. The solder bumps are arranged in such a manner so as to prevent the aforesaid inclining problem of the electronic device during surface mounting of the electronic device to a circuit board as encountered in the prior art. This invention will be described in greater detail using a condenser microphone as an example of the electronic device.

Before the present invention is described in greater detail with reference to the accompanying preferred embodiments, it should be noted herein that like elements are denoted by the same reference numerals throughout the disclosure.

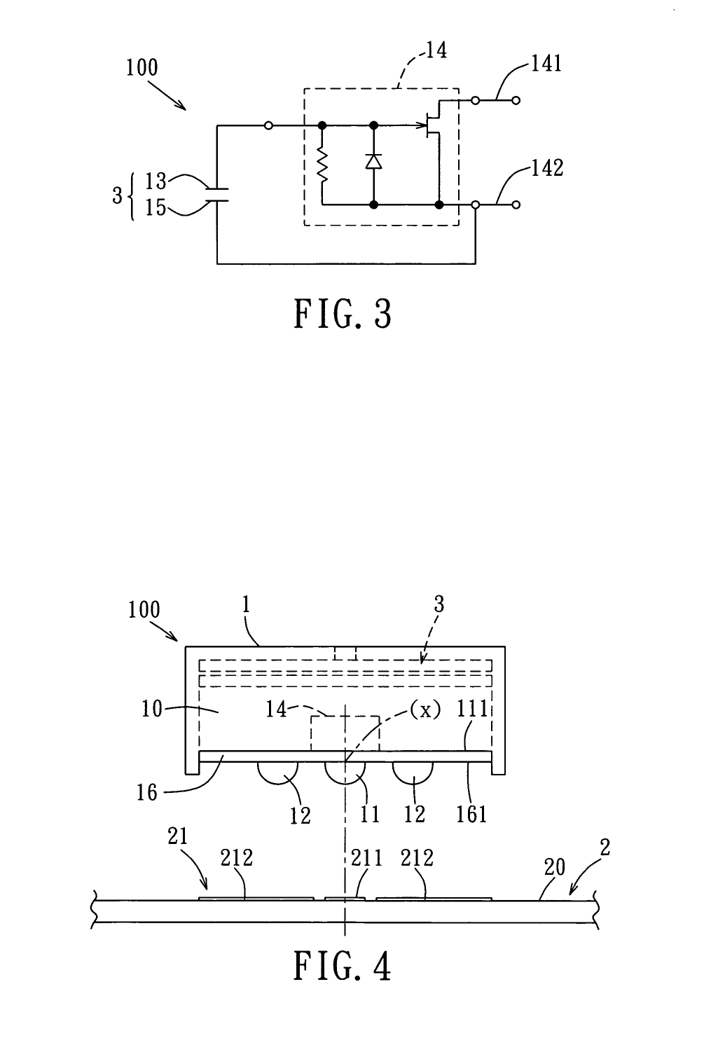

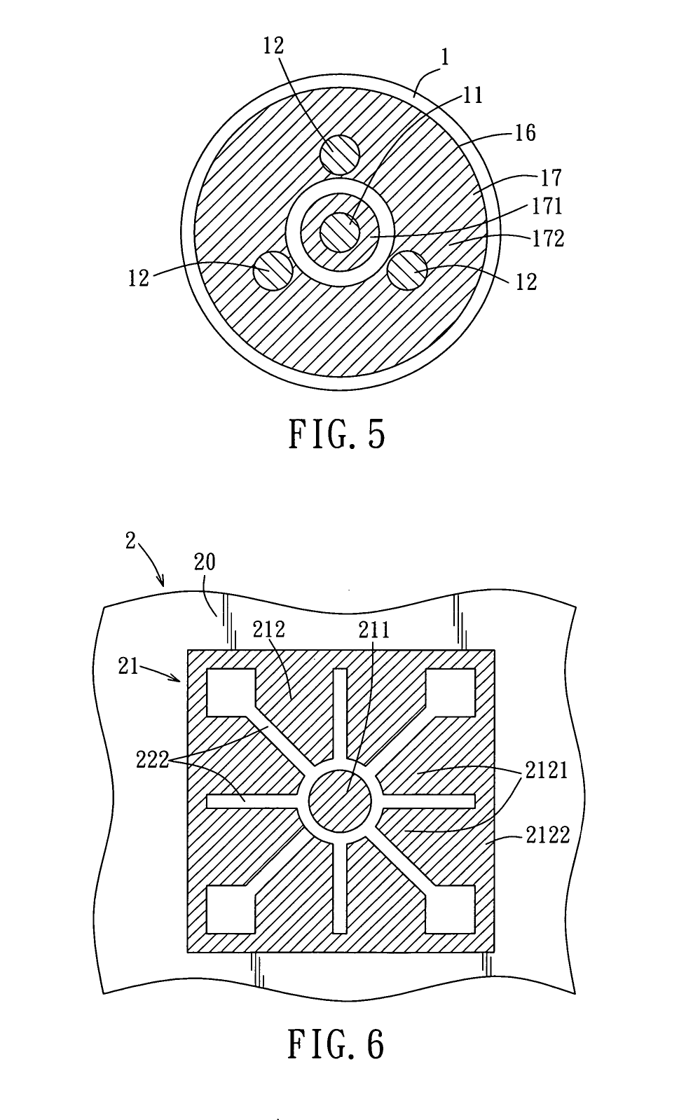

FIGS. 3 to 6 illustrate the first preferred embodiment of a condenser microphone according to the present invention. The condenser microphone 100 includes: first and second electrodes 13, 15; a field effect transistor 14 with source and drain terminals 141, 142, the source and drain terminals 141, 142 being electrically and respectively connected to the first and second electrodes 13, 15; and a housing 1 defining an accommodating space 10 for receiving the first and second electrodes 13, 15 therein and having a base 16 that confines one side of the accommodating space 10 and that has an outer surface 161 which is provided with a first solder bump 11 electrically connected to one of the first and second electrodes 13, 15, and a plurality of second solder bumps 12 connected electrically to the other of the first and second electrodes 13, 15.

In this embodiment, the first electrode 13 is a back plate and is fixed, and the second electrode 15 is a diaphragm, is movable relative to the first electrode 13, and cooperates with the first electrode 13 to form a variable capacitor 3.

Preferably, the first solder bump 11 is disposed substantially at a center (X) of the base 16, and the second solder bumps 12 are centered about the first solder bump 11 and are equiangularly displaced from each other around the first solder bump 11, thereby preventing the condenser microphone 100 from inclining during surface mounting of the condenser microphone 100 to a circuit board 2. Alternatively, the first solder bump 11 can be disposed at a position distal from the center (X) of the base 16, while the second solder bumps 12 are arranged to be centered about the center (X) of the base 16 so as to achieve the same function to prevent the condenser microphone 100 from inclining during surface mounting of the condenser microphone 100 to the circuit board 2.

The outer surface 161 of the base 16 is provided with a conductive layer 17 that has a first portion 171 and a second portion 172 separated from the first portion 171. The first solder bump 11 is formed on the first portion 171 of the conductive layer 17, whereas the second solder bumps 12 are formed on the second portion 172 of the conductive layer 17.

In this embodiment, the circuit board 2 is disposed outwardly of the housing 1, and has a mounting surface 20 that is provided with a conductive film 21 which has a first portion 211 and a second portion 212 separated from the first portion 211. The first solder bump 11 is attached to the first portion 211 of the conductive film 21, whereas the second solder bumps 12 are attached to the second portion 212 of the conductive film 21.

Preferably, the second portion 212 of the conductive film 21 surrounds the first portion 211 of the conductive film 21, and is divided by a plurality of partitioning gaps 222 so as to form the second portion 212 of the conductive film 21 into a plurality of attaching regions 2121 and a peripheral region 2122 that surrounds the attaching regions 2121 and that is connected to the attaching regions 2121. The second solder bumps 12 are selectively and respectively attached to the attaching regions 2121 of the second portion 212 of the conductive film 21. Each of the partitioning gaps 222 has a straight line section and an enlarged end section. With the inclusion of the partitioning gaps 222, connection of the second solder bumps 12 to the attaching regions 2121 can be made more secure and easier.

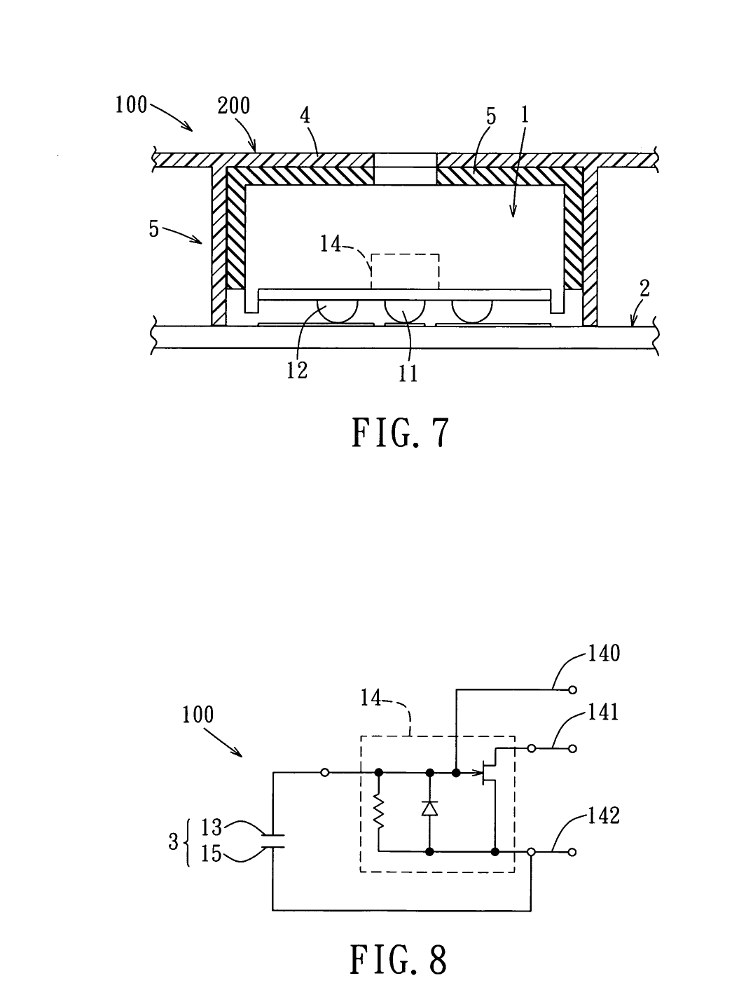

FIG. 7 illustrates the second preferred embodiment of the condenser microphone 100 according to this invention. The condenser microphone 100 of this embodiment differs from the previous embodiment in that a securing unit 200 is further included in the condenser microphone 100. The securing unit 200 includes an elastic cap member 5 that embraces an exterior of the housing 1, and a casing 4 that embraces the elastic cap member 5 and that is secured to the circuit board 2 so as to press the condenser microphone 100 against the circuit board 2, thereby securing the connection between the first solder bumps 11 and the first portion 211 of the conductive film 21 and between each second solder bump 12 and the second portion 212 of the conductive film 21.

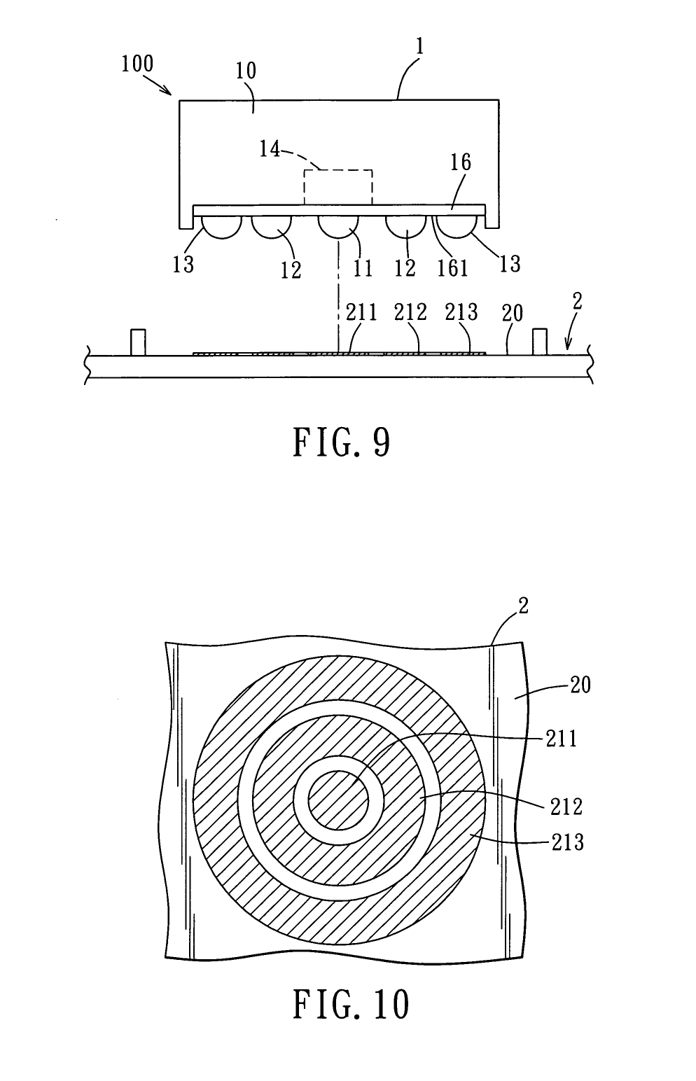

FIGS. 8 to 10 illustrate the third preferred embodiment of the condenser microphone 100 according to this invention. The condenser microphone 100 of this embodiment differs from the first preferred embodiment in that the outer surface 161 of the base 16 is further provided with a plurality of third solder bumps 13 surrounding the second solder bumps 12 for connecting electrically to a gate terminal 140 of the FET 14, and that the conductive film 21 further has a third portion 213 separated from and surrounding the second portion 212 of the conductive film 21. The third solder bumps 13 are attached to the third portion 213 of the conductive film 21. Preferably, the first, second and third portions 211, 212, 213 of the conductive film 21 are concentrically disposed on the mounting surface 20 of the circuit board 2.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An electronic device comprising:
first and second electrodes; and
a housing defining an accommodating space for receiving said first and second electrodes therein and having a base that confines one side of said accommodating space and that has an outer surface which is provided with a first solder bump electrically connected to one of said first and second electrodes, and a plurality of second solder bumps connected electrically to the other of said first and second electrodes.

2. The electronic device of claim 1, wherein said first electrode is fixed, said second electrode being movable relative to said first electrode and cooperating with said first electrode to form a capacitor.

3. The electronic device of claim 1, wherein said base has a center, said first solder bump being disposed substantially at said center of said base.

4. The electronic device of claim 3, wherein said second solder bumps are centered about said first solder bump and are equiangularly displaced from each other.

5. The electronic device of claim 1, wherein said outer surface of said base is provided with a conductive layer that has a first portion and a second portion separated from said first portion, said first solder bump being formed on said first portion of said conductive layer, said second solder bumps being formed on said second portion of said conductive layer.

6. The electronic device of claim 2, further comprising a field effect transistor that is electrically connected to said first and second electrodes.

7. The electronic device of claim 1, further comprising a circuit board disposed outwardly of said housing and having a mounting surface that is provided with a conductive film which has a first portion and a second portion separated from said first portion, said first solder bump being attached to said first portion of said conductive film, said second solder bumps being attached to said second portion of said conductive film.

8. The electronic device of claim 7, wherein said second portion of said conductive film surrounds said first portion of said conductive film, and is divided by a plurality of partitioning gaps so as to form said second portion of said conductive film into a plurality of attaching regions and a peripheral region that surrounds said attaching regions and that is connected to said attaching regions, said second solder bumps being respectively attached to said attaching regions of said second portion of said conductive film.

9. The electronic device of claim 8, wherein said second portion of said conductive film surrounds said first portion of said conductive film, said outer surface of said base being further provided with a plurality of third solder bumps surrounding said second solder bumps, said conductive film further having a third portion separated from and surrounding said second portion of said conductive film, said third solder bumps being attached to said third portion of said conductive film.

10. The electronic device of claim 9, wherein said first, second and third portions of said conductive film are concentrically disposed on said mounting surface of said circuit board.

11. A condenser microphone comprising:
first and second electrodes;
a housing defining an accommodating space for receiving said first and second electrodes therein and having a base that confines one side of said accommodating space and that has an outer surface which is provided with a first solder bump electrically connected to one of said first and second electrodes, and a plurality of second solder bumps connected electrically to the other of said first and second electrodes and centered about said first solder bump; and
a field effect transistor that is electrically connected to said first and second electrodes.

12. A condenser microphone comprising:
first and second electrodes;
a housing defining an accommodating space for receiving said first and second electrodes therein and having a base that confines one side of said accommodating space and that has a center and an outer surface which is provided with a first solder bump electrically connected to one of said first and second electrodes, and a plurality of second solder bumps connected electrically to the other of said first and second electrodes and centered substantially about the center of said base; and
a field effect transistor that is electrically connected to said first and second electrodes.
